(19) United States
(12) Patent Application Publication
(10) Pub. No.: US 2026/0155401 A1
(43) Pub. Date: Jun. 4, 2026

(54) SEPARATOR FOR FUEL CELL

(71) Applicants: Hyundai Motor Company, Seoul (KR); Kia Corporation, Seoul (KR)

(72) Inventors: Dong Geun Oh, Hwaseong-si (KR); Sun Do Shin, Hwaseong-si (KR)

(21) Appl. No.: 19/077,387

(22) Filed: Mar. 12, 2025

(30) Foreign Application Priority Data
Nov. 29, 2024 (KR) 10-2024-0174359

(51) Int. Cl. H01M 8/0258; H01M 8/0254; H01M 8/10

(52) U.S. Cl. CPC H01M 8/0258; H01M 8/0254; H01M 2008/1095

(57) ABSTRACT

A separator for fuel cells includes a number of lands arranged in columns and configured to contact and support a membrane electrode assembly and a number of channels configured to form a movement path of a reaction gas. Each channel is located between two adjacent lands. Branch parts of the lands are arranged in a first column and in an adjacent second column in a moving direction of the reaction gas. The branch parts of the lands in the first column and in the second column are arranged in a discontinuous form. Width-directional or height-directional lengths of the lands are selectively changed so that a flow rate deviation of the moving reaction gas occurs.

### CROSS-REFERENCE TO RELATED APPLICATIONS

This application claims under 35 U.S.C. § 119(a) the benefit of priority from Korean Patent Application No. 10-2024-0174359 filed on Nov. 29, 2024, the entire contents of which are incorporated herein by reference.

### TECHNICAL FIELD

The present disclosure relates to a separator for fuel cells.

### BACKGROUND

In general, a fuel cell is a device that electrochemically converts the chemical energy of fuel directly into electrical energy within the fuel cell as opposed to converting the chemical energy into heat by combustion, and is a pollution-free power generation device that is being studied with interest as a power source for vehicles, a power source for laser electric devices, etc.

Hydrogen, which is a fuel gas, is supplied to the anode of the fuel cell and oxygen, which is an oxidizer, is supplied to the cathode of the fuel cell, and in order to separate electrons from the hydrogen and oxygen and promote ionization, a humidifier is installed at each of the anode and the cathode of the fuel cell to supply moisture to the hydrogen and oxygen.

Fuel cells are classified into solid oxide fuel cells, molten carbonate fuel cells, polymer electrolyte membrane fuel cells, and direct methanol fuel cells depending on an operating temperature and an electrolyte type.

In a fuel cell, two electrochemical reactions, i.e., an oxidation reaction at an anode and a reduction reaction at a cathode, occur. In each of the two electrodes, a catalyst layer using platinum or platinum and ruthenium metal is formed to promote oxidation or reduction. Fine carbon particles are used as a catalyst support to reduce the amount of a platinum catalyst used and increase a utilization rate. The final byproducts of the reactions are electricity, heat, and water. The water generated at the cathode is in the form of water and water vapor, and is generally removed by strongly flowing a reducing gas (oxygen or air) toward the cathode.

The basic unit cell of a stack includes two electrodes, the anode and the cathode, separated by a polymer electrolyte membrane, the polymer electrolyte membrane and the anode and the cathode on the outer surface of the polymer electrolyte membrane form a membrane electrode assembly (MEA) by hot pressing, and the MEA is supported by separators having a flow path formed thereon to supply hydrogen as fuel (methanol in the case of a direct methanol fuel cell) and oxygen or air as a reducing gas and to discharge water generated by oxidation-reduction reaction. Gaskets are provided to prevent gas or liquid supplied or discharged through the flow paths of the separators from leaking out. These units cell including the MEA, the separators, and the gaskets are stacked in series to obtain required output, and the stack is formed by fixing end plates as fixing units to both ends of the unit cells.

The separators serve to electrically connect the two electrodes while preventing the fuel (hydrogen or methanol) and the reducing gas (oxygen or air) from mixing in the cell, and perform a function as mechanical supports for the stacked unit cells and a function of allowing the fuel (hydrogen or methanol) and the reducing gas (oxygen or air) to uniformly flow to the electrodes through the flow paths formed on the separators and preventing the membrane from drying out through proper moisture management. When operating a polymer electrolyte fuel cell, it is important to supply sufficiently humidified fuel and reducing gas (oxygen or air).

In the case of high current operating conditions exceeding a critical current density, an excess of water generated by the electrochemical reactions and water moved from the anode by electroosmosis is present at the cathode, some of the excess water evaporates into the reducing gas (oxygen or air) flowing channels of the separators and saturates the reducing gas, and water that does not evaporate is present in a liquid state in gas diffusion layers (GDLs) or the channels of the separators.

Excess water present in the gas diffusion layers or the separator channels, if it is not discharged to the outside by an appropriate engineering mechanism, may cause flooding, thereby causing a fatal problem in terms of fuel cell performance or reliability.

The above information disclosed in this Background section is only for enhancement of understanding of the background of the disclosure and therefore it may contain information that does not form the prior art as defined in the patent statute.

### SUMMARY

The present disclosure relates to a separator for fuel cells. In particular embodiments, it relates to a separator for fuel cells that generates a flow rate difference of a reaction gas due to a pressure difference between adjacent channels to promote material exchange between lands.

An embodiment of the present disclosure has been developed in an effort to solve the above-described problems associated with prior art. Embodiments of the present disclosure can provide a separator for fuel cells that changes the width or height of lands so that the cross-sectional areas of adjacent channels are different from each other or gaps between branch parts are different from each other, and thus can cause a flow rate deviation of a reaction gas depending on a pressure difference between the adjacent channels or branch parts to promote material exchange between the lands so as to prevent power generation performance deterioration of a stack due to flooding.

An embodiment of the present disclosure can provide a separator for fuel cells configured such that a plurality of lands configured to contact and support a membrane electrode assembly and a plurality of channels configured to form a movement path of a reaction gas are alternately repeated, wherein branch parts of the lands arranged in a first column and branch parts of the lands arranged in a second column configured to face the branch parts of the lands arranged in the first column in a moving direction of the reaction gas are arranged in a discontinuous form, and width-directional or height-directional lengths of the lands are selectively changed so that a flow rate deviation of the moving reaction gas occurs.

In an embodiment, the width-directional lengths of the lands may be changed so that a gap between a first branch part of the land arranged in the first column and a second branch part of the land arranged in the second column is narrower than a gap between a third branch part of the land arranged in the first column and a fourth branch part of the land arranged in the second column.

In an embodiment, the width-directional lengths of the land including the first branch part and the land including the second branch part may be increased, and the width-directional lengths of the land including the third branch part and the land including the fourth branch part may be decreased.

In an embodiment, the lands may be formed such that the first to fourth branch parts have a multistage structure.

In an embodiment, the height-directional lengths of the lands may be changed so that a gap between a first branch part of the land arranged in the first column and a second branch part of the land arranged in the second column is narrower than a gap between a third branch part of the land arranged in the first column and a fourth branch part of the land arranged in the second column.

In an embodiment, the height-directional lengths of the land including the first branch part and the land including the second branch part may be increased, and the height-directional lengths of the land including the third branch part and the land including the fourth branch part may be decreased.

In an embodiment, the membrane electrode assembly may be configured such that a compression ratio of portions of a gas diffusion layer configured to face the land including the first branch part and the land including the second branch part is set to be higher than a compression ratio of other portions of the gas diffusion layer configured to face the land including the third branch part and the land including the fourth branch part.

In an embodiment, the lands may be formed such that the first to fourth branch parts have a multistage structure.

In an embodiment, the lands may be configured such that cross-sectional areas of the channels formed between the lands adjacent to each other are adjusted by selectively changing the height-directional lengths of the lands continuously arranged in a direction perpendicular to the moving direction in the first column.

In an embodiment, the lands may be configured such that a cross-sectional area of the channel between a first land and a second land adjacent to each other among the plurality of lands arranged in the first column is increased more than a cross-sectional area of the channel between the first land and a third land adjacent thereto and a cross-sectional area of the channel between the second land and a fourth land adjacent thereto by decreasing the height-directional lengths of the first land and the second land adjacent to each other.

In an embodiment, the membrane electrode assembly may be configured such that a compression ratio of portions of a gas diffusion layer configured to face the third land and the fourth land is set to be higher than a compression ratio of other portions of the gas diffusion layer configured to face the first land and the second land.

In an embodiment, the lands may be configured such that cross-sectional areas of the channels formed between the lands adjacent to each other are adjusted by selectively changing the width-directional lengths of the lands continuously arranged in a direction perpendicular to the moving direction in the first column.

In an embodiment, the lands may be configured such that a cross-sectional area of the channel between a first land and a second land adjacent to each other among the plurality of lands arranged in the first column is increased more than a cross-sectional area of the channel between the first land and a third land adjacent thereto and a cross-sectional area of the channel between the second land and a fourth land adjacent thereto by increasing the width-directional lengths of the third land adjacent to the first land and the fourth land adjacent to the second land.

Other aspects and preferred embodiments of the disclosure are discussed infra.

### BRIEF DESCRIPTION OF THE DRAWINGS

The above and other features of the present disclosure will now be described in detail with reference to certain example embodiments thereof illustrated in the accompanying drawings, which are given hereinbelow by way of illustration, and thus are not necessarily limitative of the present disclosure, and wherein:

FIG. 1 is a side view showing changes in width-directional length in a separator for fuel cells according to an embodiment of the present disclosure;

FIG. 2 is a perspective view showing a branch part of the separator for fuel cells according to an embodiment of the present disclosure;

FIG. 3 is a cross-sectional view taken along line A-A of FIG. 1, showing the structure of the branch part of the separator for fuel cells according to an embodiment of the present disclosure;

FIG. 4 is a side view showing changes in height-directional length in a separator for fuel cells according to an embodiment of the present disclosure;

FIG. 5 is a cross-sectional view taken along line B-B of FIG. 4, showing the compression ratio of a gas diffusion layer to the separator for fuel cells according to an embodiment of the present disclosure;

FIG. 6 is a side view showing changes in height-directional length in a separator for fuel cells according to an embodiment of the present disclosure;

FIG. 7 is a cross-sectional view taken along line C-C of FIG. 6, showing the compression ratio of a gas diffusion layer to the separator for fuel cells according to an embodiment of the present disclosure; and

FIG. 8 is a side view showing changes in width-directional length in a separator for fuel cells according to an embodiment of the present disclosure.

It can be understood that the appended drawings are not necessarily to scale, can be presenting a somewhat simplified representation of various features illustrative of some principles of example embodiments of the present disclosure. The specific design features of the example embodiments of the present disclosure as disclosed herein, including, for example, specific dimensions, orientations, locations, and shapes can be determined in part by the particular intended application and use environment.

In the figures, reference numbers can refer to same or equivalent parts of embodiments of the present disclosure throughout the several figures of the drawing.

### DETAILED DESCRIPTION OF ILLUSTRATIVE EMBODIMENTS

Hereinafter, example embodiments of the present disclosure will be described in detail with reference to the accompanying drawings.

Advantages and features of example embodiments of the present disclosure and methods for achieving them can become apparent from the descriptions of example embodiments herein below with reference to the accompanying drawings.

However, the present disclosure is not necessarily limited to the embodiments disclosed herein but may be implemented in various different forms, and the embodiments are provided to make the description of the present disclosure thorough and to fully convey the scopes of the present disclosure to those skilled in the art. It can be noted that the scopes of the present disclosure can be defined by the claims.

In the following description of the present disclosure, a detailed description of known functions and configurations incorporated herein can be omitted if it may make the subject matter of the present disclosure rather unclear.

Among the components of each cell unit of a fuel cell stack, a membrane electrode assembly (MEA) can be located at the innermost area of each cell unit, and the membrane electrode assembly can be configured such that catalyst layers for an anode and a cathode are applied to both surfaces of a polymer electrolyte membrane 1.

Gas diffusion layers (GDLs) 10 can be located outside the membrane electrode assembly, i.e., on the outer parts of the catalyst layers, and separators having channels 200 can be formed thereon to supply fuel and discharge water generated by reactions and can be stacked on the outer parts of the gas diffusion layers 10.

In the case of the channels 200, because a plurality of lands 100 that contact and support the membrane electrode assembly can have the same width-directional length and the same height-directional length, the cross-sectional areas of the channels 200 can be also the same, and if the cross-sectional areas of the channels 200 are the same, reaction water and droplets from a humidifier may accumulate on the lands 100 and may cause flooding, and this flooding may cause deterioration of a membrane and deterioration of water dischargeability.

Accordingly, the width-directional lengths or the height-directional lengths of the plurality of channels 200 can be changed so that the cross-sectional areas of adjacent channels 200 can be different from each other, and thus can cause a flow rate deviation of the reaction gas due to a pressure difference between the channels 200, thereby being capable of promoting material exchange between the adjacent channels 200 to suppress flooding.

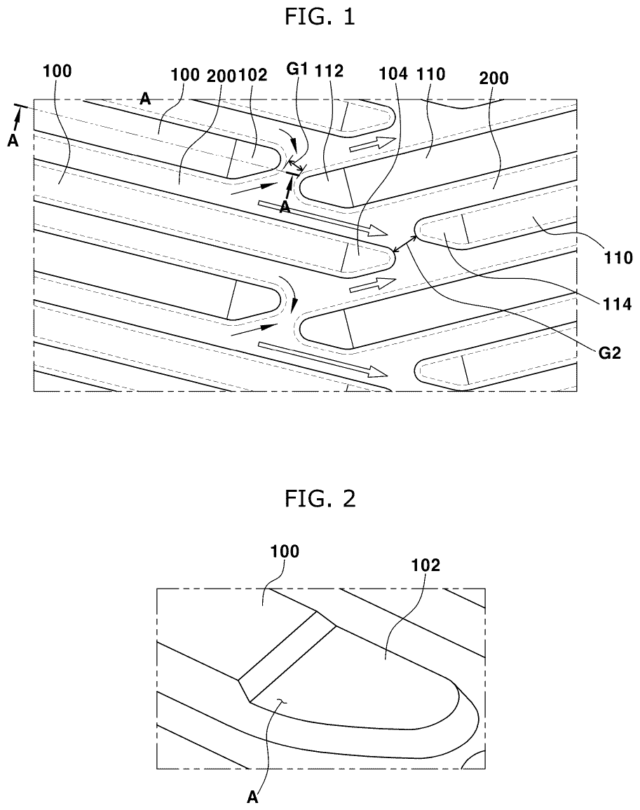

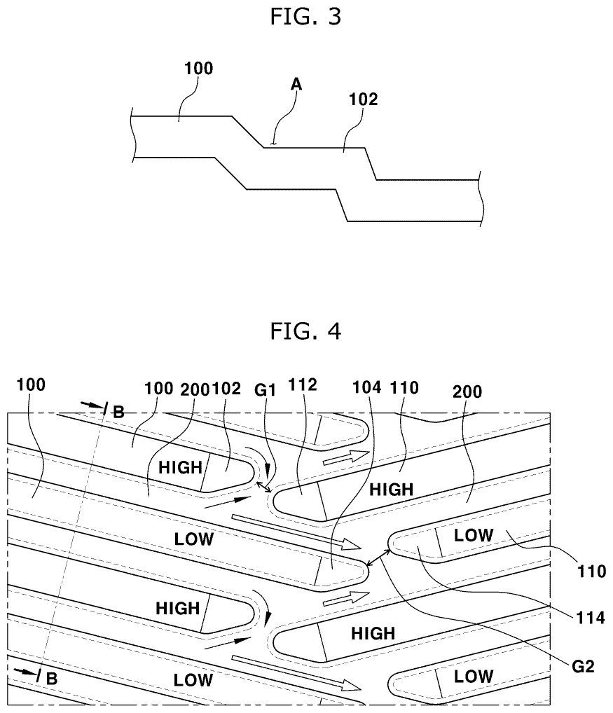

FIG. 1 is a side view showing changes in width-directional length in a separator for fuel cells according to an embodiment of the present disclosure. FIG. 2 is a perspective view showing a branch part of the separator for fuel cells. FIG. 3 is a cross-sectional view taken along line A-A of FIG. 1, showing the structure of the branch part of the separator for fuel cells.

In this embodiment, as shown in FIG. 1, branch parts 102 and 104 of a plurality of lands 100 can be arranged in a first column and branch parts 112 and 114 of a plurality of lands 110 can be arranged in a second column that face the branch parts 102 and 104 in the moving direction of a reaction gas, and can be arranged in a discontinuous form. The width-directional or height-directional lengths of the lands 100 and 110 can be selectively changed so that a flow rate deviation of the moving reaction gas can occur.

That is to say, the width-directional lengths of the lands 100 and 110 can be changed so that a gap G1 between a first branch part 102 of the land 100 arranged in the first column and a second branch part 112 of the land 110 arranged in the second column can be narrower than a gap G2 between a third branch part 104 of the land 100 arranged in the first column and a fourth branch part 114 of the land 110 arranged in the second column.

More specifically, in the lands 100 and 110, the gap G1 between the first branch part 102 of the land 100 arranged in the first column and the second branch part 112 of the land 110 arranged in the second column can be narrower than the gap G2 between the third branch part 104 of the land 100 arranged in the first column and the fourth branch part 114 of the land 110 arranged in the second column by increasing the width-directional lengths of the land 100 including the first branch part 102 and the land 110 including the second branch part 112 and decreasing the width-directional lengths of the land 100 including the third branch part 104 and the land 110 including the fourth branch part 114, thereby being capable of causing a flow rate deviation of the reaction gas moving along the channels 200.

That is, because, when gas flows through channels having different cross-sectional areas at the same flow rate, the flow velocity in the channel having the smallest cross-sectional area is the fastest and the pressure in this channel is the highest, and the flow velocity in the channel having the largest cross-sectional area is the slowest and the pressure in this channel is the lowest, if a pressure difference occurs in the channels 200 due to the changes in cross-sectional area caused by such a gap difference, a flow rate deviation can occur as a working fluid moves from an area having a narrow gap to an area having a wide gap, and the flow rate deviation can promote material exchange between the lands 100 and 110, thereby being capable of suppressing flooding over the lands 100 and 110.

Here, as shown in FIG. 2, the lands 100 and 110 may be formed such that the first, second, third, and fourth branch parts, 102, 112, 104, and 114 have a multistage structure.

More specifically, in a structure in which the branch parts 102 and 104 of the lands 100 arranged in the first column and the branch parts 112 and 114 of the lands 110 arranged in the second column facing the branch parts 102 and 104 in the moving direction of the reaction gas can be arranged in the discontinuous form, the lands 100 and 110 may be formed such that the first, second, third, and fourth branch parts 102, 112, 104, and 114 have the multistage structure, as shown in FIG. 2.

As shown in FIG. 3, which is a cross-sectional view taken along line A-A of FIG. 1, showing the structure of the branch part 102, for example, because the first branch part 102 of the land 100 can have the multistage structure and thus a portion of the height of the land 100 at the first branch part 102 can be reduced, a flow space A for the reaction gas corresponding to the reduced height may be secured, and material exchange between adjacent channels 200 may be carried out through the flow space A, thereby being capable of suppressing flooding over the land 100.

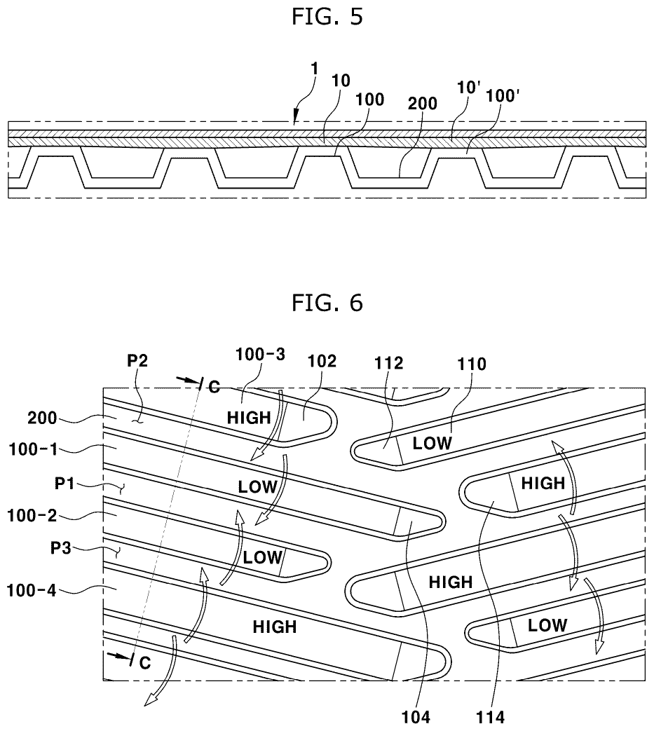

FIG. 4 is a side view showing changes in height-directional length in a separator for fuel cells according to another embodiment of the present disclosure. FIG. 5 is a cross-sectional view taken along line B-B of FIG. 4, showing the compression ratio of a gas diffusion layer to the separator for fuel cells.

In this embodiment, as shown in FIG. 4, branch parts 102 and 104 of a plurality of lands 100 arranged in a first column and branch parts 112 and 114 of a plurality of lands 110 arranged in a second column that face the branch parts 102 in the moving direction of a reaction gas can be arranged in a discontinuous form, and the width-directional or height-directional lengths of the lands 100 and 110 can be selectively changed so that a flow rate deviation of the moving reaction gas can occur.

That is to say, the height-directional lengths of the lands 100 and 110 can be changed so that a gap G1 between a first branch part 102 of the land 100 arranged in the first column and a second branch part 112 of the land 110 arranged in the second column can be narrower than a gap G2 between a third branch part 104 of the land 100 arranged in the first column and a fourth branch part 114 of the land 110 arranged in the second column.

More specifically, in the lands 100 and 110, the gap G1 between the first branch part 102 of the land 100 arranged in the first column and the second branch part 112 of the land 110 arranged in the second column can become narrower than the gap G2 between the third branch part 104 of the land 100 arranged in the first column and the fourth branch part 114 of the land 110 arranged in the second column by increasing the height-directional lengths of the land 100 including the first branch part 102 and the land 110 including the second branch part 112 and decreasing the height-directional lengths of the land 100 including the third branch part 104 and the land 110 including the fourth branch part 114, thereby being capable of causing a flow rate deviation of the reaction gas moving along the channels 200.

That is, because, when gas flows through channels having different cross-sectional areas at the same flow rate, the flow velocity in the channel having the smallest cross-sectional area is the fastest and the pressure in this channel is the highest, and the flow velocity in the channel having the largest cross-sectional area is the slowest and the pressure in this channel is the lowest, if a pressure difference occurs in the channels 200 due to the changes in cross-sectional area caused by such a gap difference, a flow rate deviation can occur as a working fluid moves from an area having a narrow gap to an area having a wide gap, and the flow rate deviation can promote material exchange between the lands 100 and 110, thereby being capable of suppressing flooding over the lands 100 and 110.

In this structure, because each of the lands 100 arranged in the first column has a height difference with adjacent lands 100 (see FIG. 3), correspondingly, as shown in FIG. 5, the compression ratio of a portion of a gas diffusion layer 10 facing the land 100 including the first branch part 102 may be set to be higher than the compression ratio of another portion 10′ of the gas diffusion layer 10 facing the land 100′ including the third branch part 104.

The lands 100 and 110 according to this embodiment may be formed such that the first, second, third and fourth branch parts, 102, 112, 104, and 114 have a multistage structure (see FIG. 2).

More specifically, in a structure in which the branch parts 102 and 104 of the lands 100 arranged in the first column and the branch parts 112 and 114 of the lands 110 arranged in the second column facing the branch parts 102 and 104 in the moving direction of the reaction gas are arranged in the discontinuous form, the lands 100 and 110 may be formed such that the first, second, third, and fourth branch parts 102, 112, 104, and 114 have the multistage structure (see FIG. 2).

Accordingly, for example, because the first branch part 102 of the land 100 has the multistage structure and thus a portion of the height of the land 100 at the first branch part 102 is reduced, a flow space A for the reaction gas corresponding to the reduced height may be secured (see FIG. 3), and material exchange between adjacent channels 200 may be carried out through the flow space A, thereby being capable of suppressing flooding over the land 100.

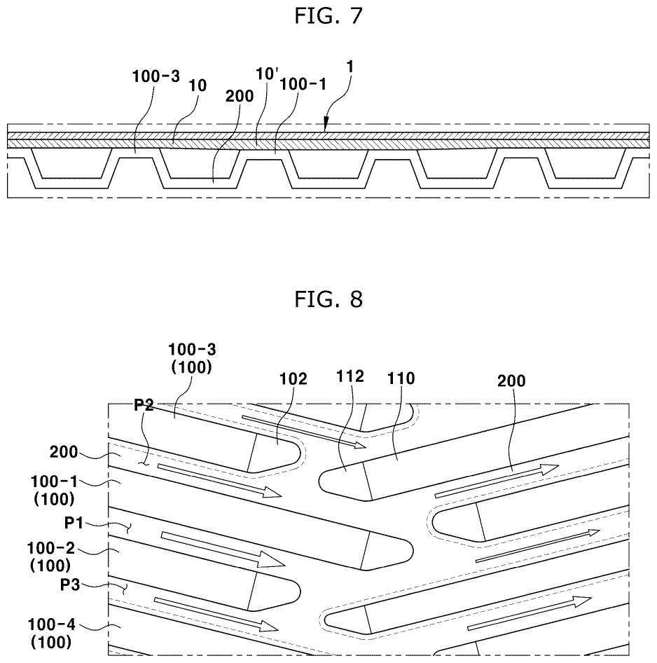

FIG. 6 is a side view showing changes in height-directional length in a separator for fuel cells according to an embodiment of the present disclosure. FIG. 7 is a cross-sectional view taken along line C-C of FIG. 6, showing the compression ratio of a gas diffusion layer to the separator for fuel cells.

In this embodiment, as shown in FIG. 6, branch parts 102 and 104 of a plurality of lands 100 arranged in a first column and branch parts 112 and 114 of a plurality of lands 110 arranged in a second column that face the branch parts 102 in the moving direction of a reaction gas can be arranged in a discontinuous form, and the width-directional or height-directional lengths of the lands 100 and 110 can be selectively changed so that a flow rate deviation of the moving reaction gas can occur.

For example, by selectively changing the height-directional lengths of the lands 100 arranged continuously in the first column in the direction perpendicular to the moving direction of the reaction gas, the cross-sectional areas of channels 200 formed between adjacent lands 100 may be adjusted.

More specifically, among the plurality of lands 100 arranged in the first column, a cross-sectional area P1 of the channel 200 between a first land 100-1 and a second land 100-2 adjacent to each other may be adjusted to be increased more than a cross-sectional area P2 of the channel 200 between the first land 100-1 and a third land 100-3 and a cross-sectional area P3 of the channel 200 between the second land 100-2 and a fourth land 100-4 by decreasing the height-directional lengths of the first land 100-1 and the second land 100-2 and increasing the height-directional lengths of the third land 100-3 and the fourth land 100-4.

That is, because, when gas flows through channels having different cross-sectional areas at the same flow rate, the flow velocity in the channel having the smallest cross-sectional area is the fastest and the pressure in this channel is the highest, and the flow velocity in the channel having the largest cross-sectional area is the slowest and the pressure in this channel is the lowest, if a pressure difference occurs in the channels 200 due to the changes in cross-sectional area caused by such height adjustment among the plurality of adjacent lands 100-1 to 100-4, a flow rate deviation can occur as a working fluid moves from an area having a small cross-sectional area to an area having a large cross-sectional area, and the flow rate deviation can promote material exchange between the lands 100-1 to 100-4, thereby being capable of suppressing flooding over the lands 100-1 to 100-4.

In this structure, each of the lands 100 arranged in the first column can have a height difference with adjacent lands 100-1 to 100-4 (see FIG. 6), correspondingly, as shown in FIG. 7, the compression ratio of a portion of a gas diffusion layer 10 facing the land 100-3 may be set to be higher than the compression ratio of another portion 10′ of the gas diffusion layer 10 facing the land 100-1.

The lands 100 and 110 according to this embodiment may be formed such that the first, second, third and fourth branch parts, 102, 112, 104, and 114 have a multistage structure (see FIG. 2).

Specifically, in a structure in which the branch parts 102 and 104 of the lands 100 arranged in the first column and the branch parts 112 and 114 of the lands 110 arranged in the second column facing the branch parts 102 and 104 in the moving direction of the reaction gas are arranged in a discontinuous form, the lands 100 and 110 may be formed such that the first, second, third, and fourth branch parts 102, 112, 104, and 114 have the multistage structure (see FIG. 2).

Accordingly, for example, because the first branch part 102 of the land 100 can have the multistage structure and thus a portion of the height of the land 100 at the first branch part 102 can be reduced, a flow space A for the reaction gas corresponding to the reduced height may be secured (see FIG. 3), and material exchange between adjacent channels 200 may be carried out through the flow space A, thereby being capable of suppressing flooding over the land 100.

FIG. 8 is a view showing changes in width-directional length in a separator for fuel cells according to another embodiment of the present disclosure.

In this embodiment, as shown in FIG. 8, branch parts 102 and 104 of a plurality of lands 100 arranged in a first column and branch parts 112 and 114 of a plurality of lands 110 arranged in a second column that face the branch parts 102 in the moving direction of a reaction gas can be arranged in a discontinuous form, and the width-directional or height-directional lengths of the lands 100 and 110 can be selectively changed so that a flow rate deviation of the moving reaction gas can occur.

For example, by selectively changing the width-directional lengths of the lands 100 arranged continuously in the first column in the direction perpendicular to the moving direction of the reaction gas, the cross-sectional areas of channels 200 formed between adjacent lands 100 may be adjusted.

More specifically, among the plurality of lands 100 arranged in the first column, a cross-sectional area P1 of the channel 200 between a first land 100-1 and a second land 100-2 adjacent to each other may be adjusted to be increased more than a cross-sectional area P2 of the channel 200 between the first land 100-1 and a third land 100-3 and a cross-sectional area P3 of the channel 200 between the second land 100-2 and a fourth land 100-4 by increasing the width-directional lengths of the third land 100-3 adjacent to the first land 100-1 and the fourth land 100-4 adjacent to the second land 100-2.

That is, because, when gas flows through channels having different cross-sectional areas at the same flow rate, the flow velocity in the channel having the smallest cross-sectional area is the fastest and the pressure in this channel is the highest, and the flow velocity in the channel having the largest cross-sectional area is the slowest and the pressure in this channel is the lowest, if a pressure difference occurs in the channels 200 due to the changes in cross-sectional area caused by such width adjustment of the third land 100-3 and the fourth land 100-4, a flow rate deviation can occur as a working fluid moves from an area having a small cross-sectional area to an area having a large cross-sectional area, and the flow rate deviation promotes material exchange between the lands 100-1 to 100-4, thereby being capable of suppressing flooding over the lands 100-1 to 100-4.

For example, the lands 100 and 110 may be formed such that a first branch part 102 of the land 100 in the first column facing a second branch part 112 of the land 110 in the second column has a multistage structure (see FIG. 2).

Specifically, in a structure in which the branch parts 102 of the lands 100 arranged in the first column and the branch parts 112 of the lands 110 arranged in the second column facing the branch parts 102 in the moving direction of the reaction gas are arranged in a discontinuous form, the lands 100 and 110 may be formed such that the branch parts 102 and 112 have the multistage structure (see FIG. 2).

Accordingly, for example, because the first branch part 102 of the land 100 can have a multistage structure and thus a portion of the height of the land 100 at the first branch part 102 can be reduced, a flow space A for the reaction gas corresponding to the reduced height may be secured (see FIG. 3), and material exchange between adjacent channels 200 may be carried out in the flow space A, thereby being capable of suppressing flooding over the land 100.

In embodiments of the present disclosure, the width or height of the lands can be changed so that the cross-sectional areas of adjacent channels are different from each other, and thus can cause a pressure difference, can enable the reaction gas to flow to the adjacent channels due to this pressure difference, and can promote material exchange between the lands, thereby having an effect of preventing power generation performance deterioration of the stack due to flooding.

In embodiments of the present disclosure, the width or height of the lands can be changed so that gaps between adjacent branch parts can be different from each other, and thus can cause a flow rate deviation of the reaction gas and can promote material exchange between the lands, and thereby can have an effect of preventing power generation performance deterioration of the stack due to flooding.

As can be apparent from the above description, embodiments of the present disclosure can change the width or height of lands so that the cross-sectional areas of adjacent channels can be different from each other, and thus can cause a pressure difference, can enable a reaction gas to flow to the adjacent channels due to this pressure difference, and can promote material exchange between the lands, and thereby can have an effect of preventing power generation performance deterioration of a stack due to flooding.

In embodiments of the present disclosure, the width or height of the lands can be changed so that gaps between adjacent branch parts can be different from each other, and thus can cause a flow rate deviation of the reaction gas and can promote material exchange between the lands, and thereby can have an effect of preventing power generation performance deterioration of the stack due to flooding.

A number of embodiments have been disclosed herein. It is understood that various features of the different embodiments can be combined.

The disclosure has been described in detail with reference to example embodiments. However, it can be appreciated by those skilled in the art that changes may be made in these embodiments without departing from the principles and spirit of the disclosure, the scopes of which can be defined in the appended claims and their equivalents.

What is claimed is:

1. A separator for fuel cells comprising:
a plurality of lands arranged in columns and configured to contact and support a membrane electrode assembly; and
a plurality of channels configured to form a movement path of a reaction gas, each channel between two adjacent lands;
wherein branch parts of the lands are arranged in a first column and in an adjacent second column in a moving direction of the reaction gas;
wherein the branch parts of the lands in the first column and in the second column are arranged in a discontinuous form; and
wherein width-directional or height-directional lengths of the lands are selectively changed so that a flow rate deviation of the moving reaction gas occurs.

2. The separator of claim 1, wherein width-directional lengths of the lands are varied so that a gap between a first branch part of the land arranged in the first column and a second branch part of the land arranged in the second column is narrower than a gap between a third branch part of the land arranged in the first column and a fourth branch part of the land arranged in the second column.

3. The separator of claim 2, wherein:
the width-directional length of the land comprising the first branch part is greater than a width-direction length of other portions of the land arranged in the first column;
the width-directional length of the land comprising the third branch part is less than the width-direction length of the other portions of the land arranged in the first column;
the width-directional length of the land comprising the second branch part is greater than a width-direction length of other portions of the land arranged in the second column; and
the width-directional length of the land comprising the fourth branch part is greater than the width-direction length of the other portions of the land arranged in the first column.

4. The separator of claim 2, wherein the first to fourth branch parts each have a multistage structure.

5. The separator of claim 1, wherein height-directional lengths of the lands are varied so that a gap between a first branch part of the land arranged in the first column and a second branch part of the land arranged in the second column is narrower than a gap between a third branch part of the land arranged in the first column and a fourth branch part of the land arranged in the second column.

6. The separator of claim 5, wherein:
the height-directional length of the land comprising the first branch part is greater than a height-direction length of other portions of the land arranged in the first column;
the height-directional length of the land comprising the third branch part is less than the height-direction length of the other portions of the land arranged in the first column;
the height-directional length of the land comprising the second branch part is greater than a height direction length of other portions of the land arranged in the second column; and
the height-directional length of the land comprising the fourth branch part is greater than the height-direction length of the other portions of the land arranged in the first column.

7. The separator of claim 6, wherein the membrane electrode assembly is configured such that a compression ratio of portions of a gas diffusion layer configured to face the land comprising the first branch part and the land comprising the second branch part is set to be higher than a compression ratio of other portions of the gas diffusion layer configured to face the land comprising the third branch part and the land comprising the fourth branch part.

8. The separator of claim 5, wherein the first to fourth branch parts each have a multistage structure.

9. The separator of claim 1, wherein cross-sectional areas of the channels formed between lands adjacent to each other are varied due to varied height-directional lengths of the lands continuously arranged in a direction perpendicular to the moving direction in the first column.

10. The separator of claim 9, wherein the lands are configured such that a cross-sectional area of the channel between a first land and a second land adjacent to each other among the plurality of lands arranged in the first column is greater than a cross-sectional area of the channel between the first land and a third land adjacent thereto and a cross-sectional area of the channel between the second land and a fourth land adjacent thereto due to smaller height-directional lengths of the first land and the second land adjacent to each other.

11. The separator of claim 10, wherein the membrane electrode assembly is configured such that a compression ratio of portions of a gas diffusion layer configured to face the third land and the fourth land is set to be higher than a compression ratio of other portions of the gas diffusion layer configured to face the first land and the second land.

12. The separator of claim 1, wherein cross-sectional areas of the channels formed between the lands adjacent to each other vary due to varying width-directional lengths of the lands continuously arranged in a direction perpendicular to the moving direction in the first column.

13. The separator of claim 12, wherein a cross-sectional area of the channel between a first land and a second land adjacent to each other among the plurality of lands arranged in the first column is greater than a cross-sectional area of the channel between the first land and a third land adjacent thereto and a cross-sectional area of the channel between the second land and a fourth land adjacent thereto by increasing the width-directional lengths of the third land adjacent to the first land and the fourth land adjacent to the second land.

14. A separator for a fuel cell comprising:
a first land extending along a first diagonal direction in a first column;
a second land extending along a second diagonal direction in a second column, wherein the second diagonal direction intersects the first diagonal direction, wherein a first gap is between the first land and the second land;
a third land extending along a third diagonal direction in the first column, wherein the third diagonal direction is parallel with the first diagonal direction, wherein a first channel is between the first land and the third land; and
a fourth land extending along a fourth diagonal direction in the second column, wherein the fourth diagonal direction intersects the third diagonal direction, and wherein the fourth diagonal direction is parallel with the second diagonal direction, where a second channel is between the second land and the fourth land, wherein a second gap is between the third land and the fourth land, wherein the first gap is not aligned with the second gap, wherein the first gap is smaller than the second gap.

15. The separator of claim 14, wherein a first width-direction length of the first land and the second land is different than a second width-direction length of the third land and the fourth land.

16. The separator of claim 15, wherein the first width-direction length of the first land and the second land is greater than the second width-direction length of the third land and the fourth land.

17. The separator of claim 14, wherein a first height-direction length of the first land and the second land is different than a second height-direction length of the third land and the fourth land.

18. The separator of claim 17, wherein the first height-direction length of the first land and the second land is greater than the second height-direction length of the third land and the fourth land.

19. The separator of claim 14, wherein each of the first land, the second land, the third land, and the fourth land have a stepped-thickness structure at a tip thereof adjacent to the first gap and the second gap.

20. The separator of claim 14, wherein a first width-direction length and/or a first height-direction length of the first land and the fourth land is different than a second width-direction length and/or a second height-direction length of the second land and the third land.
